(19) United States
(12) Patent Application Publication
(10) Pub. No.: US 2016/0154546 A1
(43) Pub. Date: Jun. 2, 2016

(54) CONTROL PANEL FOR PROVIDING SHORTCUT FUNCTION AND METHOD OF CONTROLLING USING THE SAME

(71) Applicant: HYUNDAI MOTOR COMPANY, Seoul (KR)

(72) Inventors: Sihyun JOO, Seoul (KR); Dongsoo SHIN, Suwon-si (KR); Jongmin OH, Ulsan (KR); Jungsang MIN, Seoul (KR)

(21) Appl. No.: 14/726,413

(22) Filed: May 29, 2015

(30) Foreign Application Priority Data
Nov. 28, 2014 (KR) 10-2014-0169043

(51) Int. Cl. G06F 3/0482; G06F 3/0484

(52) U.S. Cl. CPC G06F 3/0482; G06F 3/04842; G06F 3/04847

(57) ABSTRACT

A control panel for providing shortcut functions includes: n shortcut buttons capable of being pressed; a memory storing 2ⁿ-−1 patterns according to combinations of the n shortcut buttons; and a controller configured to map a shortcut function to each of one or more of the 2ⁿ−1 patterns, determine one or more shortcut buttons pressed by a driver's finger based on press signals received from the n shortcut buttons, determine the pattern that corresponds to the one or more pressed buttons, generate a control command for executing the shortcut function mapped to the determined pattern, and output the control command to a corresponding device from among a plurality of control target devices.

### CROSS-REFERENCE TO RELATED APPLICATION

This application claims the benefit of priority to Korean Patent Application No. 1 0-201 4-01 69043 filed in the Korean Intellectual Property Office on Nov. 28, 2014, the entire contents of which are incorporated herein by reference.

### TECHNICAL FIELD

The present invention relates to a control panel. More particularly, the present invention relates to a control panel for providing shortcut functions.

### BACKGROUND

In order to simplify manipulation of a radio device mounted within a vehicle, preset functions are provided. In general, a plurality of preset buttons for setting and executing preset functions are disposed in a center fascia. A driver may allocate the plurality of preset buttons to desired radio frequencies. Accordingly, the driver can rapidly search the desired radio frequencies by pressing the preset buttons without searching radio frequencies via a dial knob.

Various electronic devices such as an audio video navigation (AVN) device, an air conditioner, and a head-up display (HUD) device are mounted within the vehicle for a driver's convenience. Accordingly, the driver performs a large number of manipulations to search a desired function from among functions of the electronic devices. For example, in a procedure in which the driver searches for a destination, the driver selects the AVN device from among the electronic devices, searches a destination search menu of the AVN device, and then finally inputs a desired destination. The driver needs to look at an input device and a display for searching the desired function while the vehicle is running, and thus the driver's attention may be diverted from a road and the vehicle may depart from a driving lane.

Like the preset buttons of the radio device, if desired functions of the electronic devices are set to shortcut functions by using buttons, driver's convenience and safe driving can be expected. However, a large number of buttons are needed to set all desired functions as shortcut functions.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide, in various embodiments, a control panel for providing shortcut functions having advantages of minimizing diversion of user's attention, the number of shortcut buttons, and disposition space of the shortcut buttons.

A control panel for providing shortcut functions according to an exemplary embodiment of the present invention may include: n shortcut buttons capable of being pressed; a memory storing 2ⁿ−1 patterns according to combinations of the n shortcut buttons; and a controller configured to map a shortcut function to each of one or more of the 2ⁿ−1 patterns, determine one or more pressed shortcut buttons based on press signals received from the n shortcut buttons, determine the pattern that corresponds to the one or more pressed buttons, generate a control command for executing the shortcut function mapped to the determined pattern, and output the control command to a corresponding device from among a plurality of control target devices.

In certain embodiments, the controller may be further configured to map a currently activated function to the pattern corresponding to the one or more pressed buttons when the one or more pressed buttons are pressed for a set amount of time. In certain embodiments, the control panel may further include: n touch sensors respectively disposed on portions of the n shortcut buttons and configured to sense a driver's touch; and a display configured to display an image based on a display command of the controller, wherein the controller may be configured to determine one or more touched touch sensors based on touch signals received from the n touch sensors, determine the pattern that corresponds to the one or more touched sensors, generate the display command for displaying the shortcut function mapped to the determined pattern, and output the display command to the display.

In certain embodiments, the display may simultaneously display the determined pattern and the shortcut functions mapped to the determined pattern.

In certain embodiments, the controller may be further configured to map a currently activated function to the pattern corresponding to the one or more touched touch sensors when the one or more touched touch sensors are touched for a set amount of time. In certain embodiments, n may be selected from the group consisting of 2, 3, and 4.

In certain embodiments, the n shortcut buttons may be disposed on a center fascia.

In certain embodiments, the n shortcut buttons may be disposed on a steering wheel.

In certain embodiments, the n shortcut buttons may be disposed between a gear knob and an armrest.

In certain embodiments, the n shortcut buttons may be disposed on a door at a driver's seat.

In certain embodiments, a control panel for providing shortcut functions includes: three shortcut buttons capable of being pressed; three touch sensors respectively disposed on upper portions of the three shortcut buttons and configured to sense a driver's touch; a memory storing seven patterns according to combinations of the three shortcut buttons; a controller configured to map a shortcut function to each of one or more of seven patterns, determine one or more pressed shortcut buttons based on press signals received from the three shortcut buttons, determine the pattern that corresponds to the one or more pressed shortcut buttons, generate a control command for executing the shortcut function mapped to the determined pattern, and output the control command to a corresponding device from among a plurality of control target devices; and a display configured to display an image based on a display command of the control panel, wherein the controller may determine one or more touched touch sensors based on touch signals received from the three touch sensors, determine the pattern that corresponds to the one or more touched touch sensors, generate the display command for displaying the shortcut function mapped to the determined pattern, and output the display command to the display.

In certain embodiments, the controller may be further configured to map a currently activated function to the pattern corresponding to the one or more pressed shortcut buttons when the one or more pressed shortcut buttons are pressed for a set amount of time. In certain embodiments, the controller may be further configured to map a currently activated function to the pattern corresponding to the one or more touched touch sensors when the one or more touched touch sensors are touched for a set amount of time.

In certain embodiments, the display may simultaneously display both the determined pattern and the shortcut function mapped to the determined pattern.

In certain embodiments, the three shortcut buttons may be disposed on a center fascia.

In certain embodiments, the three shortcut buttons may be disposed on a steering wheel.

In certain embodiments, the three shortcut buttons may be disposed between a gear knob and an armrest.

In certain embodiments, the three shortcut buttons may be disposed on a door at a driver's seat.

According to another exemplary embodiment of the present invention, a method of controlling a plurality of control target devices using a control panel including n shortcut buttons and a memory storing 2ⁿ−1 patterns according to combinations of the n shortcut buttons is disclosed. The method includes: mapping a shortcut function to each of one or more of the 2n−1 patterns; determining one or more pressed shortcut buttons based on press signals received from the n shortcut buttons; determining a pressed pattern corresponding to the one or more pressed buttons; if the pressed pattern has a corresponding mapped shortcut function, generating a control command for executing the mapped shortcut function corresponding to the pressed pattern, and outputting the control command to a corresponding device from among the plurality of control target devices.

According to exemplary embodiments of the present invention, 2ⁿ−1 shortcut functions according to combinations of n shortcut buttons are provided, thereby minimizing diversion of a user's attention, the number of shortcut buttons, or disposition space of the shortcut buttons.

### BRIEF DESCRIPTION OF THE DRAWINGS

FIG. 1 illustrates an inside of a vehicle including a control panel according to an exemplary embodiment of the present invention.

FIG. 2 illustrates a block diagram of a control panel for providing shortcut functions according to an exemplary embodiment of the present invention.

FIG. 3 illustrates seven patterns stored in a memory according to an exemplary embodiment of the present invention.

FIG. 4 illustrates three patterns stored in a memory according to another exemplary embodiment of the present invention.

FIG. 5A-5C illustrates images displayed on a display according to an exemplary embodiment of the present invention.

### DETAILED DESCRIPTION

In the following Detailed Description, exemplary embodiments of the present invention will be described more fully hereinafter with reference to the accompanying drawings. However, the present invention is not limited to the exemplary embodiments which are described herein, and may be modified in various different ways.

Accordingly, the drawings and description are to be regarded as illustrative in nature and not restrictive. Like reference numerals designate like elements throughout the specification.

Since each component shown in the drawings is arbitrarily illustrated for easy description, the present invention is not particularly limited to the components illustrated in the drawings.

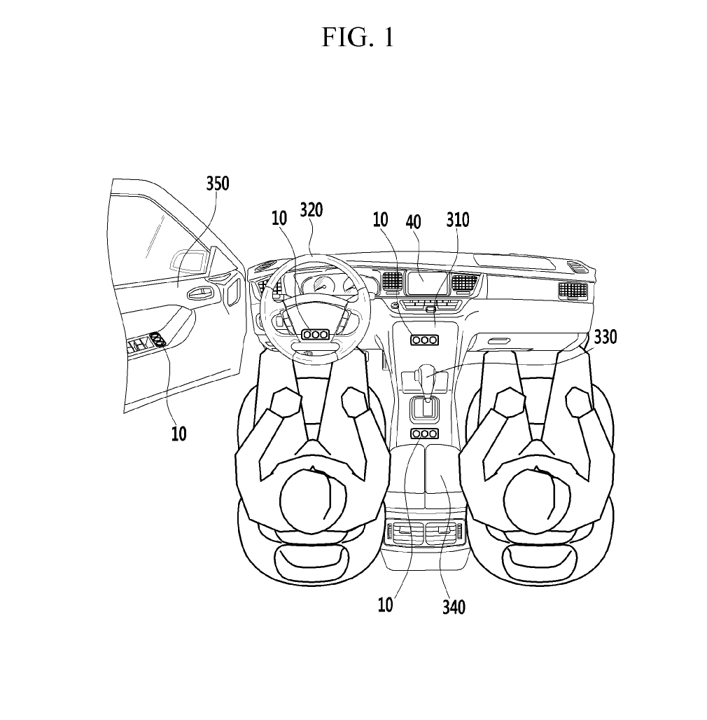

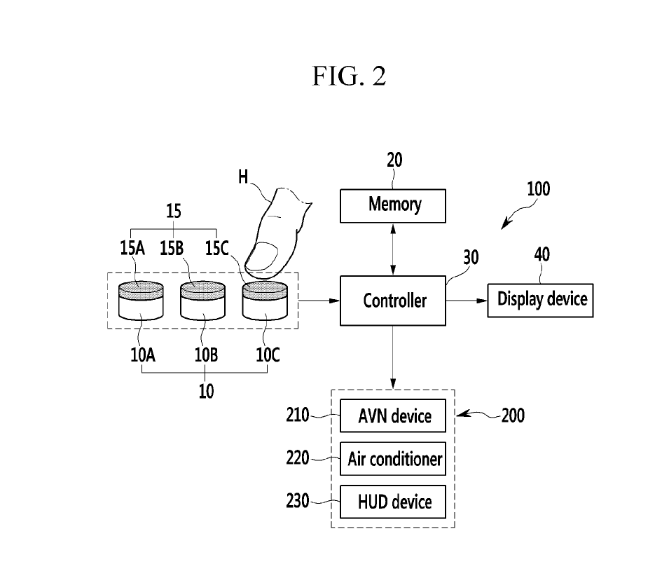

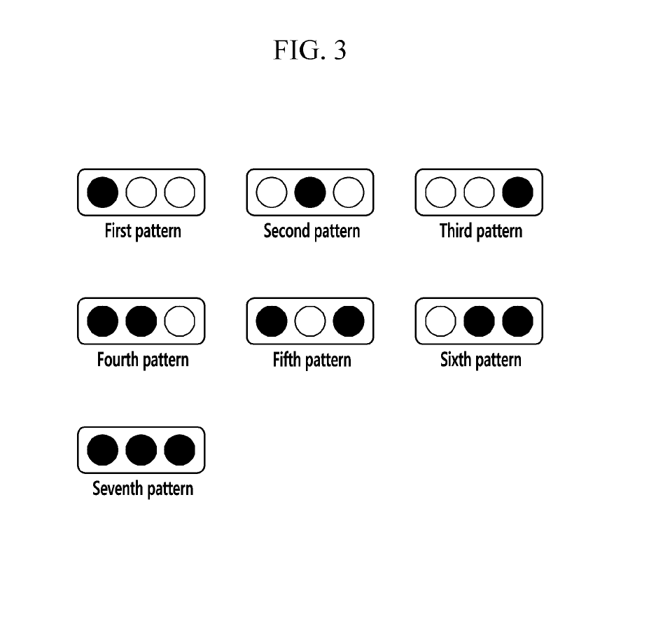

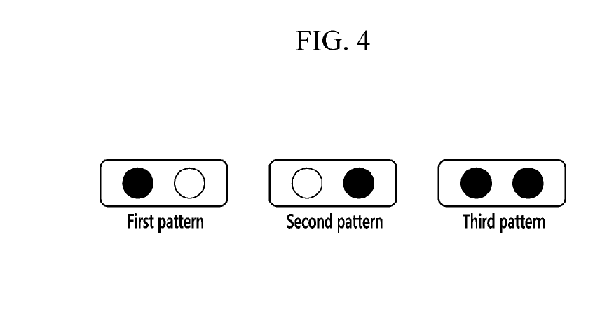

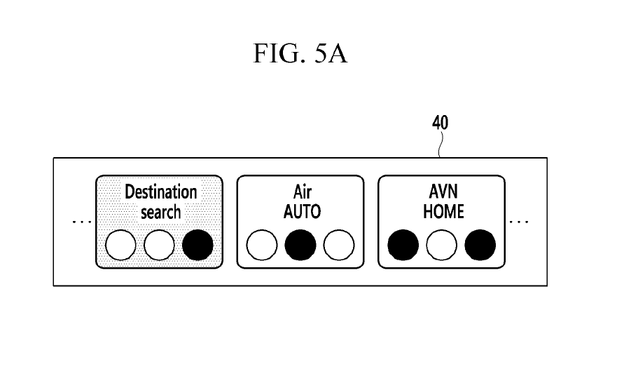

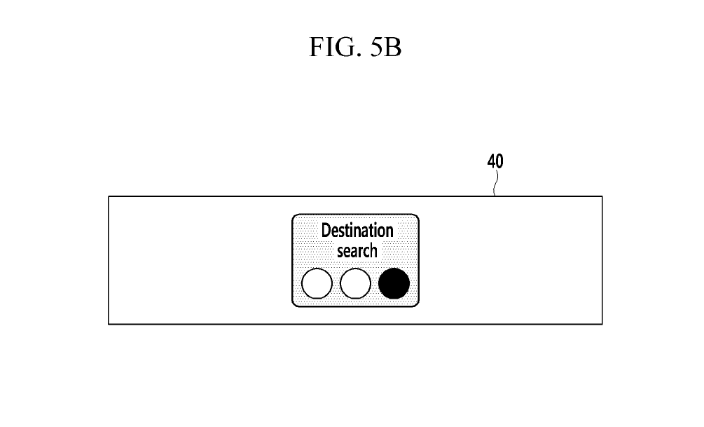

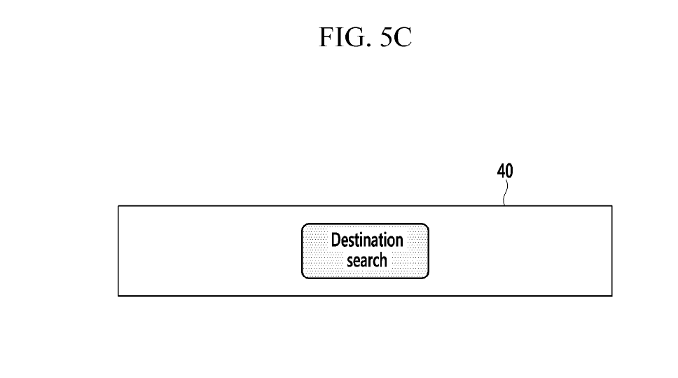

FIG. 1 illustrates an inside of a vehicle including a control panel according to an exemplary embodiment of the present invention, FIG. 2 illustrates a block diagram of a control panel for providing shortcut functions according to an exemplary embodiment of the present invention, FIG. 3 illustrates seven patterns stored in a memory according to an exemplary embodiment of the present invention, FIG. 4 illustrates three patterns stored in a memory according to an exemplary embodiment of the present invention, and FIGS. 5A-C illustrate images displayed on a display according to exemplary embodiments of the present invention.

As shown in FIG. 1 to FIG. 5, a control panel 100 for providing shortcut functions according an exemplary embodiment of the present invention may include n shortcut buttons 10, a memory 20, and a controller 30. In certain embodiments, the control panel 100 may also include n touch sensors 15 and a display 40.

The n shortcut buttons 10 may be pressed by a user such as a driver or a passenger. The n shortcut buttons 10 may be disposed in an appropriate position in order to enhance the user's convenience. For example, the n shortcut buttons 10 may be disposed on a center fascia 310, on a steering wheel 320, between a gear knob 330 and an armrest 340, or on a door 350 at a driver's seat. The n is a natural number of 2 or more. In certain embodiments, n may be one of 2, 3, and 4. When n is 5 or more, with the exception of the center fascia 310, it may be difficult to find a sufficiently large and convenient area in which to dispose the buttons. A user may press one or more of the n shortcut buttons 10, and press signals are transmitted from the n shortcut buttons 10 to the controller 30.

In certain embodiments, the n touch sensors 15 may be respectively disposed on portions of the n shortcut buttons 10. In certain embodiments, the portions may be upper portions. Each of n touch sensors 15A, 15B, and 15C may detect a driver's touch and transmit a touch signal corresponding thereto to the controller 30.

2ⁿ−1 patterns according to combinations of the n shortcut buttons 10 are stored in the memory 20. As shown in FIG. 3, seven patterns (i.e., first to seventh patterns) according to combinations of three shortcut buttons 10A, 10B, and 100 are exemplified herein, but the present invention is not limited thereto. As shown in FIG. 4, in the case that two shortcut buttons are used, three patterns may be stored in the memory 20. The memory 20 may store a set program for an operation of the controller 30 and temporarily store input/output data.

Hereinafter, the case where n is 3 will be mainly described. The case where n is 2 or 4 is similar to the case where n is 3, so a detailed description of cases where n is 2 or 4 will be omitted.

In certain embodiments, the controller 30 may be implemented with one or more microprocessors executed by the set program. The set program may include a series of commands for performing each step included in a method for controlling the control panel according to an exemplary embodiment of the present invention described below.

In certain embodiments, the display 40 may be a component of an audio video navigation (AVN) device 210 or a head-up display (HUD) device 230. The display 40 may display an image including information based on a display command of the controller 30. For example, the image may include AVN device information, air conditioner information, HUD device information, and the like. In certain embodiments, the image may include information indicating operation states of the AVN device 210, an air conditioner 220, and the HUD device 230, and a plurality of graphics objects that are selectable. A graphics object refers to information that is selected and controlled by the intention of the driver. For example, the graphics object may include an icon, text, contents, or a list.

The controller 30 is connected to a plurality of control target devices 200. For example, in certain embodiments, the plurality of control target devices 200 may include the AVN device 210, the air conditioner 220, and the HUD device 230. The controller 30 may generate control commands to execute functions of the plurality of the control target devices 200, and output the control commands to a corresponding device. The functions may be various application functions of the plurality of control target devices 200. For example, in certain embodiments, the functions may include a destination search function of the AVN device 210, an air/temperature control function of the air conditioner 220, and a brightness control function of the HUD device 230.

In certain embodiments, when one or more shortcut buttons among the three shortcut buttons 10A, 10B, and 100 are pressed for a set time, the controller 30 may set a currently activated function as the shortcut function. The set time may be arbitrarily set by a person of ordinary skill in the art. For example, when the driver presses the shortcut button 10C for the set time in the state where the destination search function of the AVN device 210 is activated, the destination search function may be set as the shortcut function. In this example, the controller 30 maps the destination search function to the third pattern.

Alternatively, when one or more touch sensors among the three touch sensors 15A, 15B, and 15C are touched for the set time, the controller 30 may set the currently activated functions as the shortcut function. For example, when the driver touches the touch sensor 15C for the set time in the state where the destination search function of the AVN device 210 is activated, the destination search function may be set as the shortcut function. In this case, the controller 30 maps the destination search function to the third pattern.

Accordingly, the controller 30 may set functions desired by the driver as the shortcut functions from among application functions of the plurality of control target devices 200, and map shortcut functions to a maximum of seven patterns in the current embodiment. The maximum number of patterns in different embodiments depends on the number of shortcut buttons. As described hereinabove, n shortcut buttons may yield a maximum of 2ⁿ−1 patterns

In certain embodiments, the controller 30 may display the shortcut functions mapped to the patterns via the display 40. For example, the controller 30 may determine the touched touch sensor 15C based on touch signals received from the touch sensors 15A, 15B, and 15C, and determine the third pattern corresponding to the touched touch sensor. In this case, the controller 30 may generate the display command for displaying the shortcut function (i.e., the destination search function) mapped to the third pattern, and output the display command to the display 40.

Referring to FIG. 5A, in certain embodiments, the display 40 may simultaneously display all currently set shortcut functions and patterns. In this case, the display 40 may emphasize the third pattern and the destination search function that correspond to the touched touch sensor 15C.

Referring to FIG. 5B, in certain embodiments, the display 40 may simultaneously display only the third pattern and the destination function that correspond to the touched touch sensor 15C. In this case, as compared to FIG. 5A, display regions for displaying the shortcut functions can be reduced, and it is possible for the driver to accurately check the third pattern for executing the destination search function.

Referring to FIG. 5C, in certain embodiments, the display 40 may display only the destination search function that corresponds to the touched touch sensor 15C. In this case, display regions for displaying the shortcut functions can be minimized.

As described above, according to exemplary embodiments of the present invention, 2ⁿ−1 shortcut functions according to combinations of n shortcut buttons are provided, thereby minimizing diversion of driver's attention, the number of shortcut buttons, and disposition space of the shortcut buttons.

While exemplary embodiments of this invention have been described herein, it is to be understood that the invention is not limited to the disclosed embodiments, but, on the contrary, is intended to cover various modifications and equivalent arrangements included within the spirit and scope of the appended claims.

What is claimed is:

1. A control panel for providing shortcut functions, comprising:
n shortcut buttons capable of being pressed;
a memory storing 2ⁿ−1 patterns according to combinations of the n shortcut buttons; and
a controller configured to map a shortcut function to each of one or more of the 2ⁿ−1 patterns, determine one or more pressed shortcut buttons based on press signals received from the n shortcut buttons, determine the pattern that corresponds to the one or more pressed buttons, generate a control command for executing the shortcut function mapped to the determined pattern, and output the control command to a corresponding device from among a plurality of control target devices.

2. The control panel of claim 1, wherein the controller is further configured to map a currently activated function to the pattern corresponding to the one or more pressed buttons when the one or more pressed buttons are pressed for a set amount of time.

3. The control panel of claim 1, further comprising:
n touch sensors respectively disposed on portions of the n shortcut buttons and configured to sense a driver's touch; and
a display configured to display an image based on a display command of the controller,
wherein the controller is configured to determine one or more touched touch sensors based on touch signals received from the n touch sensors, determine the pattern that corresponds to the one or more touched touch sensors, generate the display command for displaying the shortcut function mapped to the determined pattern, and output the display command to the display.

4. The control panel of claim 3, wherein the display simultaneously displays both the determined pattern and the shortcut function mapped to the determined pattern.

5. The control panel of claim 3 the controller is further configured to map a currently activated function to the pattern corresponding to the one or more touched touch sensors when the one or more touched touch sensors are touched for a set amount of time.

6. The control panel of claim 1, wherein n is selected from the group consisting of 2, 3, and 4.

7. The control panel of claim 1, wherein the n shortcut buttons are disposed on a center fascia.

8. The control panel of claim 1, wherein the n shortcut buttons are disposed on a steering wheel.

9. The control panel of claim 1, wherein the n shortcut buttons are disposed between a gear knob and an armrest.

10. The control panel of claim 1, wherein the n shortcut buttons are disposed on a door at a driver's seat.

11. A control panel for providing shortcut functions, comprising:
three shortcut buttons capable of being pressed;
three touch sensors respectively disposed on upper portions of the three shortcut buttons and configured to sense a driver's touch;
a memory storing seven patterns according to combinations of the three shortcut buttons;
a controller configured to map a shortcut function to each of one or more of the seven patterns, determine one or more pressed shortcut buttons based on press signals received from the three shortcut buttons, determine the pattern that corresponds to the one or more pressed shortcut buttons, generate a control command for executing the shortcut function mapped to the determined pattern, and output the control command to a corresponding device from among a plurality of control target devices; and
a display configured to display an image based on a display command of the control panel,
wherein the controller determines one or more touched touch sensors based on touch signals received from the three touch sensors, determines the pattern that corresponds to the one or more touched touch sensors, generates the display command for displaying the shortcut function mapped to the determined pattern, and outputs the display command to the display.

12. The control panel of claim 11, wherein the controller is further configured to map a currently activated function to the pattern corresponding to the one or more pressed shortcut buttons when the one or more pressed shortcut buttons are pressed for a set amount of time.

13. The control panel of claim 11, wherein the controller is further configured to map a currently activated function to the pattern corresponding to the one or more touched touch sensors when the one or more touched touch sensors are touched for a set amount of time. .

14. The control panel of claim 11, wherein the display simultaneously displays both the determined pattern and the shortcut function mapped to the determined pattern.

15. The control panel of claim 11, wherein the three shortcut buttons are disposed on a center fascia.

16. The control panel of claim 11, wherein the three shortcut buttons are disposed on a steering wheel.

17. The control panel of claim 11, wherein the three shortcut buttons are disposed between a gear knob and an armrest.

18. The control panel of claim 11, wherein the three shortcut buttons are disposed on a door at a driver's seat.

19. A method of controlling a plurality of control target devices using a control panel including n shortcut buttons and a memory storing 2ⁿ−1 patterns according to combinations of the n shortcut buttons, the method comprising:
mapping a shortcut function to each of one or more of the 2ⁿ−1 patterns;
determining one or more pressed shortcut buttons based on press signals received from the n shortcut buttons;
determining a pressed pattern corresponding to the one or more pressed buttons;
if the pressed pattern has a corresponding mapped shortcut function, generating a control command for executing the mapped shortcut function corresponding to the pressed pattern, and
outputting the control command to a corresponding device from among the plurality of control target devices.

20. The method of claim 19, further comprising:
if the pressed shortcut buttons are pressed for a set amount of time, mapping a currently activated function to the pressed pattern.
